(19) United States
(12) Patent Application Publication
(10) Pub. No.: US 2008/0300902 A1
(43) Pub. Date: Dec. 4, 2008

(54) METHOD OF IDENTIFYING LOCATIONS EXPERIENCING ELEVATED LEVELS OF ABUSE OF OPIOID ANALGESIC DRUGS

(75) Inventors: Meredith Y. Smith, CHAPPAQUA, NY (US); William Irish, RALEIGH, NC (US); Jianmin Wang, Carrboro, NC (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: PURDUE PHARMA L.P., STAMFORD, CT (US)

(21) Appl. No.: 11/940,299

(22) Filed: Nov. 14, 2007

Related U.S. Application Data
(60) Provisional application No. 60/865,854, filed on Nov. 15, 2006.

(51) Int. Cl. G06Q 99/00; G06F 17/10

(52) U.S. Cl. 705/1

(57) ABSTRACT

In the field of pharmacovigilance (monitoring of adverse events associated with the use of marketed prescription drugs), an improved method of detecting “signals” of abuse or diversion of pharmaceuticals is needed, in order to more reliably distinguish real anomalies in pharmaceutical consumption in particular locations from apparent anomalies which are statistical artifacts of high local concentrations of authorized pharmaceutical users. An improved method relies upon government statistics on adverse drug reactions and on census statistics, and employs a Poisson statistical model to adjust for both fixed effects and random effects, such as spatial relations between different locations. The more accurate “signals” provided by the improved method permit public health and law enforcement officials to allocate public resources more efficiently and effectively.

### FIELD OF THE INVENTION

The present invention relates generally to methods of identifying where prescription drug abuse and diversion is clustered geographically and, more particularly, to an improved identification method which adjusts for differences in the volume of dispensing of specific prescription drugs over time, within and across different localities. The term “dispense” means, in this context, to provide a medication in the amount, or at the rate, prescribed or specified by an authorized medical professional, for treatment of a named recipient. In the following discussion, we call it “prescription drug abuse” when, in order to reach a state of euphoria (“get high”), a patient intentionally consumes more of a drug than the doctor prescribed, or when an individual for whom the drug was not prescribed consumes the drug expressly for the purpose of getting high, and we call it “prescription drug diversion” when a drug is taken out of the legitimate supply chain for the purposes of re-sale and/or distribution on the black market (e.g. when an employee steals (diverts) drugs from a pharmacy, a hospital, or other type of healthcare facility where s/he works and then sells it to others).

Both prescription drug abuse and diversion necessitate effective government action in order to minimize the well-known social costs associated with drug abuse, addiction, drug trafficking and other associated crimes. To assist in the design and deployment of interventions, a method is needed to identify potential “signals” of high drug abuse and/or diversion occurring within specific geographic locales. An important first step in accomplishing this objective is to determine, or mathematically estimate, how much abuse of a specific prescription drug is “usual” or “expected” for a given geographic area in a specific time period. When one knows this, one can then detect when an abuse level in a specific locale is an anomalous or unusual abuse level. A value which stands out statistically is referred to as an “outlier.”

The inventive method permits more accurate identification of those localities where abuse and/or diversion of specific prescription drugs may be unusually or excessively high (i.e., may constitute a potential signal), by adjusting for the usual level of dispensing of the specific prescription drug of interest within a given community. Such a method is of direct benefit to governments and other entities with an interest in combating prescription drug abuse, as they can then use this information to prioritize efforts to prevent and/or reduce prescription this problem. In principle, the method could also be used to detect under-consumption of a prescription drug, but that is not the primary focus of this disclosure.

### BACKGROUND

Modern medicine has developed a number of drugs for controlling pain, commonly known as analgesics. Milder analgesics, such as aspirin, acetaminophen and ibuprofen, are available without prescription. However, the most potent pain medications are those which are derived from the opium plant (“opioids”) or chemical compounds with similar structures.

Because opioid analgesics have abuse potential, they are dispensed only by prescription in the United States and many other western countries. Governments in most developed nations compile statistics about how many prescription drugs are consumed, and where, and when an Adverse Drug Reaction (ADR), such as an overdose, happens. For example, on behalf of the World Health Organization (WHO), the Uppsala Monitoring Centre in Sweden has maintained a database of adverse drug reactions reported from 70 countries worldwide since 1968. Similarly, the US Food & Drug Administration (FDA) maintains a national database, the Adverse Event Reporting System or AERS, which monitors reports of adverse events associated with the use of prescription drugs. These reports are counted using the first three digits (3 DZ) of the five-digit US postal code, the ZIP code.

The choice of what geographical unit to use is somewhat arbitrary. Although the geographic unit in the following description is all postal codes which share the same three left-most digits, the same method could, in principle, be applied to larger, smaller, or differently drawn geographic units for which data could be collected, and the present invention is not limited to 3 DZ. For example, the method could be used in another nation having a different postal district boundary system. In order to detect when and where prescription drug abuse is higher, there is a need for statistical methods to assist in identifying unusually frequent drug-event combinations within a given time period and geographic location of a given drug. Such combination, when found, can serve as a warning of a potentially “excessively” high level of prescription drug abuse and/or diversion within a given community. In this regard, statistical methods, previously developed to detect potential “signals” of other types of adverse event associated with the use of a particular drug, may be applicable.

One such approach often used in complex situations where multiple factors or variables interact, is to create a statistical model, intended to resemble how the variables relate to outcomes in the real world, use the statistical model to predict outomes, and check how closely the results match the real world, and possibly adjust the model to achieve a better match or “fit” with observed data. Regression analysis is one commonly employed statistical modeling tool. The primary objectives when applying regression analysis are to explain what has happened and to predict what will happen, and potentially identify unusual occurrences.

One method that has been used for signal detection purposes in analyzing drug safety datasets includes the Empirical Bayes Geometric Mean (EBGM). The EBGM method was developed by William DuMouchel; see DuMouchel W., “Bayesian Data Mining in Large Frequency Tables,” The American Statistician, 43: 177-202 (1999). This method assumes that the observed number of counts for a specific adverse event-drug combination follows a Poisson distribution, and that the mean of the Poisson distribution is mu (Greek letter μ). One pays attention to the ratio mu/E where E is the expected count if there is no drug/event interaction, and the ratio is treated in the statistical model as a random variable drawn from a mixture of two gamma distributions, one of which is concentrated near 1, and the other of which is highly dispersed.

The term “Poisson distribution” is named after the French mathematician S. D. Poisson (1781-1840) and is well known among statisticians. This method is thus often described as a “Poisson-Gamma model.” A major limitation of this approach, however, is that it does not employ a denominator—that is to say, it has no measure of the degree of exposure to the drug within the at-risk population. Moreover, the Poisson-Gamma model does not allow for the inclusion of multiple factors which may be associated with a social problem.

Another tested method is the Bayesian Confidence Propagation Neural Network (BCPNN) method, which quantifies the degree to which a specific drug-ADR combination is different from the “background” reports of drug consumption or abuse and ADR (Adverse Drug Reactions), using Bayesian statistical principles to quantify apparent dependencies in the data set. The term “Bayesian” refers to a branch of the mathematical theory of probability, named after the English mathematician Thomas Bayes (1702-1761). The term “neural network” refers to a computational approach in which a series of locations or nodes, and connections between them, are defined, and values computed at one node are used as input to a calculation at another node. One advantage of this approach is that all drug-ADR combinations can be analyzed in an automated manner. However, like the Poisson-Gamma method, this BCPNN method also fails to adjust for differing drug exposures of the respective local populations, and does not allow for the inclusion of multiple factors.

### SUMMARY OF THE INVENTION

Accordingly, in order to more accurately identify statistically significant high prescription drug abuse values (“outliers” or “signals”), there is a need for a statistical analysis method which does adjust for differing levels of drug exposure within the respective local populations, and allows for inclusion of multiple factors. A significant contribution of the present method is that it uses a denominator consisting of the number of unique individuals within a given time frame and location who have been dispensed at least one prescription for the drug of interest (referred to as Unique Recipients of Dispensed Drugs or URDDs), as a proxy for the number of persons exposed to a particular drug within a defined time period and geographic area. Incorporation of a denominator into a Poisson regression model permits more accurate identification of those localities which are at higher risk for experiencing drug abuse and/or diversion than others.

Further, when drug abuse and/or diversion occurs in a particular location, policymakers need to know what factors appear to contribute to the problem. Accordingly, the statistical method of the present invention facilitates analysis of what demographic and geographic factors are associated with an anomalous level of abuse or diversion, for example by incorporating into the statistical model factors such as income, age, and gender.

The model includes both fixed effects to represent time period, drug, and other local characteristics (e.g. income, age, gender) and spatially correlated random effects to estimate the unique contribution of the specific geographic locale (as represented, for example, by using the 3 digit ZIP code or “3 DZ”). The fixed effects and random effects are estimated using [a maximum likelihood approach, and the random effects are estimated using Markov Chain Monte Carlo statistical techniques which combine the maximum likelihood principle and empirical Bayes estimation. This technique has been applied in two separate databases to date:

(1) a Poison Control Center (PCC) dataset which contains reports by 3 DZ of the number of intentional exposures to specific opioid analgesics within a calendar quarter; and

(2) a dataset containing quarterly reports on the number of opioid-analgesic-related arrests and drug seizures that occurred within a calendar quarter, within defined geographic locales, as reported by a network of federal, state and local law enforcement agents (referred to as the “Drug Diversion” study).

Once an “outlier” location has been flagged, it is preferably given a distinctive graphical representation. For example, it can be displayed on a map with a distinctive color or a simulated 3-dimensional peak, or a list of “outlier” locations can be generated for action by government officials. If the outlier locations show a sufficiently wide range in outlier values of abuse or diversion, a spectrum of colors can be used, for example, to designate ascending categories of outliers: yellow for lowest levels, orange for intermediate levels, and red for the highest levels.

### BRIEF FIGURE DESCRIPTION

FIG. 1 is a matrix which sets forth indicator variables for the term Di (representing respective different drugs) in the equation of the regression model of the present invention;

FIG. 2 shows the β parameters used in the mathematical model of the invention and the results of the regression analysis on a Poison Control (PC) dataset, including the estimate value, standard error and 95% confidence intervals;

FIG. 3 is a matrix showing pair-wise comparisons (expressed as relative report rates with two-side 95% confidence intervals) among six opioid analgesics in the Poison Control (PC) dataset;

FIG. 4 is a list of geographic locations (3-digit ZIP codes=3 DZ) in Poison Control Center data, which were “flagged” as “outliers” according to the method of the invention;

FIG. 5 is a pie chart showing a percentage breakdown of the opioid analgesics involved, for which the drug-by time-by 3 DZ combination was found to indicate an unusually high level of abuse, based on Poison Center (PC) data;

FIG. 6 is a chronological table, by quarter year, of those 3 DZ locations where reports, derived from Poison Center (PC) data, indicated an usually high level of abuse of OxyContin®;

FIG. 7 is a chronological table, by quarter year, of those 3 DZ locations where reports, derived from Poison Center data, indicated an unusually high level of abuse of fentanyl;

FIG. 8 is a chronological table, by quarter year, of those 3 DZ locations where reports, derived from Poison Center (PC) data, indicated an unusually high level of abuse of hydrocodone;

FIG. 9 is a chronological table, by quarter year, of those 3 DZ locations where reports, derived from Poison Center (PC) data, indicated an unusually high level of abuse of hydromorphone;

FIG. 10 is a chronological table, by quarter year, of those 3 DZ locations where reports, derived from Poison Center (PC) data, indicated an unusually high level of abuse of morphine;

FIG. 11 is a chronological table, by quarter year, of those 3 DZ locations where reports, derived from Poison Center (PC) data, indicated an unusually high level of abuse of oxycodone;

FIG. 12 is a chronological table, by quarter year, of those 3 DZ locations where reports, derived from Poison Center (PC) data, indicated an unusually high level of abuse of methadone;

FIG. 13 shows the β parameters used in the mathematical model of the invention and the results of the regression analysis on a Diversion Study dataset, including an estimate value, standard error and 95% confidence intervals;

FIG. 14 shows pair-wise comparisons among the six opioid analgesics in the Diversion Study dataset;

FIG. 15 is a pie chart showing a percentage breakdown of the drugs involved, for which drug-by time-by 3 DZ combinations from the Diversion Study dataset, indicated unusually high diversion of opioids;

FIG. 16 is a chronological table, by quarter year, of those 3 DZ locations where reports, derived from diversion study data, indicated unusually high diversion of OxyContin®;

FIG. 17 is a chronological table, by quarter year, of those 3 DZ locations where reports, derived from diversion study) data, indicated unusually high diversion of fentanyl;

FIG. 18 is a list of 3-digit ZIPcodes which the method of the present invention “flagged” locations in the Diversion Study dataset, with empirical Bayes estimate, Rate Ratio, and p-value;

FIG. 19 is a chronological table, by quarter year, of those 3 DZ locations where reports, derived from Diversion Study data, indicated unusually high levels of diversion of hydrocodone combination products;

FIG. 20 is a chronological table, by quarter year, of those 3 DZ locations where reports, derived from Diversion Study data, indicated unusually high levels of diversion of hydromorphone;

FIG. 21 is a chronological table, by quarter year, of those 3 DZ locations where reports, derived from Diversion Study data, indicated unusually high levels of diversion of morphine;

FIG. 22 is a chronological table, by quarter year, of those 3 DZ locations where reports, derived from Diversion Study data, indicated unusually high levels of diversion of oxycodone; and

FIG. 23 is a chronological table, by quarter year, of those 3 DZ locations where reports, derived from Diversion Study data, indicated unusually high diversion of methadone.

### DETAILED DESCRIPTION

Opioid analgesic abuse is a serious public health problem affecting some 4.6 million Americans each month, according to the Substance Abuse and Mental Health Administration, Results from the 2005 National Survey on Drug Abuse and Health: National Findings (Office of Applied Studies, NSDUH Series H-30, Publication No. SMA 06-4194 (US Dept. of Health & Human Services, Rockville Md., 2006)). To study the prevalence and nature of opioid analgesic abuse and diversion, a national surveillance system (the Researched Abuse, Diversion and Addition-Related Surveillance System or RADARS® (US Service Mark 2,799,192), owned and operated by Denver Health and Hospital Authority, has been established. The RADARS System consists of four independently-operated ongoing research studies that collect information concerning patterns of abuse and diversion of, and addiction to, nine opioid analgesics: buprenorphine, fentanyl, hydrocodone combination products, hydromorphone, methadone, morphine, immediate-release oxycodone, generic modified-release oxycodone products and OxyContin®) at the 3-digit ZIP code (3 DZ)level by calendar quarter. The four studies are: (1) Poison Control Center study (PCC); (2) Drug Diversion study; (3) Key Informant study; and (4) the Opioid Treatment Program (OTP) study. Data from these four studies are reviewed quarterly by an independent outside panel of experts.

In order to respond to reports of abuse and diversion of these nine products in the most timely, efficient and appropriate manner, it was recognized that there was a need for a method that could distinguish reports which were unusually high. To address this challenging problem, 2 sets of data from the RADARS® system were used (1) intentional exposure data were obtained for each calendar quarter (time) at the (3 DZ) level, for each drug, from up to 15 Poison Control Centers (PCC) for the period Quarter 1, 2003-Quarter 4, 2004; and (2) drug diversion data from the Drug Diversion study for the time period Quarter 1, 2002 through Quarter 4, 2004.

Data also included the number of Unique Recipients of Dispensed Drugs (URDDs) per calendar quarter for each of the nine monitored drugs in each of the participating 3 DZs. URDDS figures were used as a proxy for the number of persons exposed to a particular drug. The number of reports per 1,000 URDDs was calculated separately for each of the nine monitored drugs for the PCC and the Drug Diversion study data. Drug-specific report rates were calculated for each time period, overall and by 3 DZ.

Based on the statistical model, we can estimate the extent to which the abuse (PCC study) or diversion (Drug Diversion study) of each of the nine monitored opioid analgesics varies as a function of the level of legitimate dispensing of each drug within the 3-digit ZIP code of concern, as well as the level of dispensing in adjacent 3 DZs. Drugs are likely to be smuggled, or otherwise transported, to nearby locations, a “spatial effect.”

The present invention is directed to using statistical methods to identify locations with high rates of opioid analgesic abuse and diversion from datasets specific to drug abuse and diversion in combination with databases (such as the U.S. census) that contain community-level demographic (e.g. age, income, and race) breakdowns and geographic location, e.g. latitude & longitude of each 3 DZ. The method of the present invention can incorporate a different selection of community-level factors or variables, and is not limited to the specific factors in the datasets described here.

The invention employs several well-known statistical tools; the novelty of the present invention lies in finding the proper combination and “tuning” of these statistical techniques, as described below, best suited to the available datasets, so as to perform effective surveillance of prescription drug abuse and diversion.

For the Poison Control Center (PCC) and Drug Diversion datasets mentioned above, a spatial mixed effects Poisson regression is used in which random effects are used to incorporate the proximity of 3 DZs and to correlate reports over time. A Conditional Auto-Regressive (CAR) function is used to describe the correlation of reports between time periods. For example, counts in two calendar quarters which are near each other in time are more likely to resemble each other than are the counts in two quarters widely separated in time. This can be called a “temporal effect.”

A preferred first step in conducting the analysis is to graph the data and to remove extreme values which would otherwise distort the analysis of the remaining data in the dataset. For example, if a fraction is being calculated, in which the number of Unique Recipients of a Dispensed Drug is the denominator, but data for a particular ZIP code indicates zero prescriptions written that calendar quarter, the data are disregarded because one cannot divide by zero. Next, a local regression (“Loess”) technique” is used to interpolate (fill in) or extrapolate missing or deleted values, as described by W. S. Cleveland in “Robust Locally Weighted Regression and Smoothing Scatterplots,” Journal of the American Statistical Society, Vol. 74, pp. 829-836 (1979).

After removing the aforementioned extreme values in the first step, a preferred next step is to define a data structure which incorporates spatial effects to perform a Poisson regression analysis which predicts the logarithm of intentional exposure calls (for PCC) or drug diversion reports (for Drug Diversion study) for each of the monitored opioid drugs.

A mixed effect Poisson regression model was fit to the PC and Diversion Study databases. The fitted model for the specified database can be written as follows, with Yᵢⱼₖ-Poisson (uᵢⱼₖ):

$$log ( {μ}_{ijk} ) = log ( {N}_{ijk} ) + {β}_{0} + {\sum }_{i = 1}^{8} {β}_{i} {D}_{i} + {β}_{9} Time + {β}_{10} Age + {β}_{11} Race + {β}_{12} Income + {b}_{k} + {T}_{j}$$

where μ is the mean of the distribution, Nᵢⱼₖ is the URDD for drug I at time j in 3 DZ k, Dᵢ (I=1, . . . 8) are indicator variables for drug, Time is a continuous variable representing year-quarter, Race is the percent of white people in 3 DZ k, Age is the percent of individuals age 18 to 24 years in 3 DZ k, Income is the median household income (US $100,000) for 3 DZ k, bₖ is the 3 DZ random effect, and Tⱼ is a year-quarter random effect.

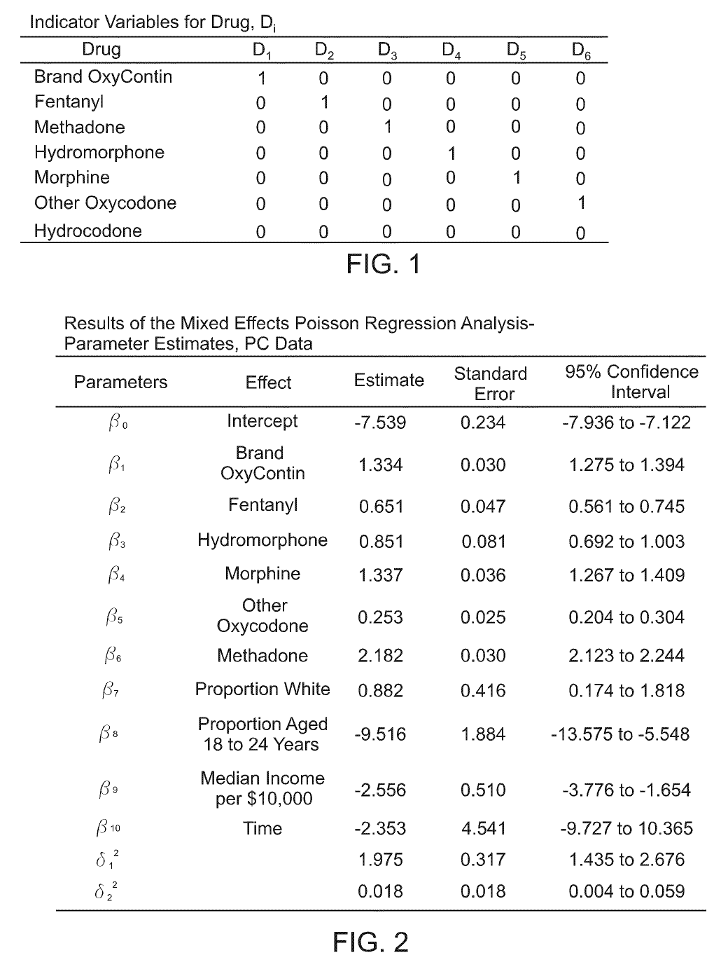

In the model, drug, time, age, race, and median household income were incorporated as fixed effects. The effect of a drug was incorporated into the model using indicator variables with the drug hydrocodone used as the reference drug, as shown in the matrix of FIG. 1. The variables time, age, race, and median household income were incorporated into the model as covariates. For each unique 3 DZ, a random intercept bₖ was incorporated into the model and assumed to follow a normal distribution with mean zero and specified variance-covariance structure (see matrix below). Time was also included as a random effect with a conditional autoregressive (CAR) structure.

The model assumes the random effect bₖ (k=1, n) follows a multivariate normal distribution

$$[ \begin{matrix}{b}_{1} \\ {b}_{2} \\ ⋮ \\ ⋮ \\ ⋮ \\ {b}_{n}\end{matrix} ] ∼ N ( [ \begin{matrix}0 \\ 0 \\ ⋮ \\ ⋮ \\ ⋮ \\ 0\end{matrix} ] , {σ}_{1}^{2} [ \begin{matrix}1 … … … … … \\ … 1 f ( {d}_{k 1 , k 2} ; φ ) \\ … … … … … … \\ … … … … … … \\ f ( {d}_{k 1 , k 2} ; φ ) 1 … \\ … … … … … 1\end{matrix} ] )$$

where d_{k1,k2} is the distance between two 3 DZs and

$$f ( {d}_{k 1 , k 2} ; φ ) = \{ \begin{matrix}\frac{2}{π} [ {cos}^{- 1} ( {d}_{k 1 , k 2} / φ ) - \sqrt{\frac{{d}_{k 1 , k 2}}{φ} ( 1 - \frac{{d}_{k 1 , k 2}^{2}}{{φ}^{2}} )} ] & for {d}_{k 1 , k 2} < φ \\ 0 & for {d}_{k 1 , k 2} \geq φ\end{matrix}$$

The time random effect is assumed to follow a conditional autoregressive structure defined as:

$$\{ \begin{matrix}{T}_{1} \vert {T}_{- 1} ∼ N ( {T}_{2} , {σ}_{2}^{2} ) \\ {T}_{j} \vert {T}_{- j} ∼ N ( ( {T}_{j - 1} + {T}_{j + 1} ) / 2 , {σ}_{2}^{2} / 2 ) \\ {T}_{l} \vert {T}_{- l} ∼ N ( {T}_{l - 1} , {σ}_{2}^{2} )\end{matrix} \\ for j = 1 , 2 , … , l - 1$$

One object of the invention is to use spatial data analysis techniques, combined with mixed effect Poisson regression, to detect outlier reports of abuse and diversion of opioid analgesics at the 3 DZ-code level. With geographic-specific data, such as that collected through the PCC and the Drug Diversion studies at the 3 DZ level, it is more reasonable to assume that two 3 DZ effects from two adjacent 3 DZ areas are correlated, rather than to assume they are independent, because it is more likely that adjacent 3 DZs share some common characteristics. Spatial analysis was developed to deal with this situation, whereby correlation among the random effects of geographic neighbors is taken into account. The general idea is to incorporate in the modeling procedure a function that describes the correlation among 3 DZs. This function is defined such that the correlation between two 3 DZs is negatively related to the distance between them.

The correlation goes to zero when the distance between 3 DZs goes beyond a given limit, for example 100 miles (160.9 kilometers).

The PCC and Diversion study datasets were used for this analysis. Both datasets or databases include the following five variables:

Drug code (1=OxyContin®, 2=fentanyl, 3=hydrocodone, 4=hydromorphone, 5=morphine, 6=other oxycodone, 7=methadone, 8=buprenorphine, 9=generic extended-release oxycodone);

Time—Data in calendar quarters from the PCC study are from 2003Q1 to 2004Q4, and the data from the Drug Diversion study are from 2002Q1 to 2004Q4;

3DZ;

Number of reports; and

Number of URDDs.

In addition to the above variables, median income, proportion of individuals between 18 and 24 years of age, and proportion of individuals who were Caucasian were obtained at the 3 DZ level using Census 2000 data, available at http://factfinder.census.gov.

As noted above, the effect of drugs on report rates is represented by the parameters β₁ through β₆ in the model¹, with the drug hydrocodone used as the reference drug. After fitting the Poisson regression model with the spatial-correlated, random intercepts, we obtained estimates of the parameters, along with an estimate of their variance-covariance matrix. Based on these fundamental results, we estimated specific linear combinations of these parameters by using the normal approximation assured by large sample theory. The linear combination of parameters included comparisons between any pair of drugs. The relative report rate is reported, expressed as exp(βi), along with associated two-sided 95% confidence intervals. ¹The opioid analgesics buprenorphine and generic extended-release oxycodone were removed from the analysis due to insufficient number of counts in the dataset.

The 3 DZ random effect, bₖ, was estimated, based on the empirical posterior distribution. Large values of bₖ suggest higher-than-average reporting rates for the k^{th} 3 DZ. Screening problem 3 DZs for further evaluation was achieved by evaluation of the empirical posterior distribution of bk.

Based on estimates of the β (beta) parameters in the model equation, we calculated the expected number of reported events Yᵢⱼₖ for any given combination of drug, time period, and 3 DZ.

Using this estimate, we then calculated the ratio of the observed number of reports to the expected number of reports. Two-sided 95% confidence intervals for the ratio were calculated using exact methods. The null hypothesis, that the observed number of reports follows a Poisson distribution with parameter equal to the expected number of reports, was tested using exact methods. A two-sided p-value less than 0.05 was used as a criterion for detecting an unusually high frequency of drug-by time-by 3 DZ reporting events.

### Coordinate Conversion and Distance Calculation

The distance between centers of two 3-digit ZIP code areas was calculated by converting longitude and latitude to Cartesian (x, y) coordinates. Distance calculations are needed for model fitting, as these determine the correlation among all ZIP code areas. To do this, we first obtained longitude and latitude for all five-digit ZIP codes in the United States, and converted these to Cartesian coordinates using Proc GPROJECT in SAS for Windows software (v. 9; SAS Institute, Cary, N.C.). The term “Proc” is short for “procedure” as more fully explained in training materials available at WWW.SUPPORT.SAS.COM. SAS® is US Trademark Reg. 1,132,122 and its owner is the holder of more than 20 US software patents, as those in the statistics art know. Next, because PC and Diversion Study data are at the 3 DZ level, we obtained the center of each 3 DZ area by averaging the coordinates of all five-digit ZIP codes corresponding to a 3 DZ. Finally, we calculated the map distance, d_{k1,k2}, between any two 3 DZs using the following formula:

d_{k1,k2}=\sqrt{(xₖ₁−xₖ₂)²+(yₖ₁−yₖ₂)²}

where xₖ₁ and yₖ₁ are the average Cartesian coordinates for 3 DZ k1 and xₖ₂ and yₖ₂ are the average Cartesian coordinates for 3 DZ k2.

### WinBUGS

The model described above was fit to the data using WinBUGS software, developed beginning in 1989 in England, jointly by the Medical Research Council BioStatistics Unit in Cambridge, England and Imperial College School of Medicine, London, England. Further details are available at WWW.MRC-BSU.CAM.AC.UK. WinBUGS is an interactive Windows version of the BUGS (Bayesian inference Using Gibbs Sampling) program for Bayesian analysis of complex statistical models using Markov Chain Monte Carlo (MCMC) techniques. In principle, other programs which perform Markov Chain Monte Carlo functions could be used to achieve the same objective. Data is input to WinBUGS as three components that can be in the same or different files. The first component is a series of model specification instructions, the second contains the observed data, and the third contains a set of starting values.

For spatial mixed-effect Poisson regression, the following model instructions are needed:

model {

for (i in 1:n)
{
case[i]~dpois(mu[i])
mu[i]<−

exp(beta0+beta1*d1[i]+beta2*d2[i]+beta4*d4[i]+beta5*d5[i]+beta6*d6[i]
+beta7*d7[i]+beta8*time[i]+beta10*white[c[i]]+beta12*age[c[i]]+beta13
*income[c[i]]+u[c[i]]+v[t[i]]+log(offset[i]))
}
u[1:m]~spatial.disc(mu1[ ],x[ ],y[ ],tau,0.02532)
v[1:8]~car.normal(adj[ ],weights[ ],num[ ],tau1)
beta0 ~ dnorm(0.0,1.0E−6)
beta1 ~ dnorm(0.0,1.0E−6)
beta2 ~ dnorm(0.0,1.0E−6)
beta4 ~ dnorm(0.0,1.0E−6)
beta5 ~ dnorm(0.0,1.0E−6)
beta6 ~ dnorm(0.0,1.0E−6)
beta7 ~ dnorm(0.0,1.0E−6)
beta8 ~ dnorm(0.0,1.0E−6)
beta10 ~ dnorm(0.0,1.0E−6)
beta12 ~ dnorm(0.0,1.0E−6)
beta13 ~ dnorm(0.0,1.0E−6)
tau~dgamma(0.001, 0.001)
tau1~dgamma (0.001, 0.001)
s2<−1/tau
s3<−1/tau1
}

where u[1:m] specifies the 3 DZ spatial relationship as defined above, with Φ=0.02532 (or 100 miles=160.9 kilometers) and v[1:8] specifies the conditional autoregressive structure for time.

### Observed Data

Three datasets that contained the observed data are required so that the above model specification can be properly implemented. These datasets include (1) data at the 3 DZ by time by drug level; (2) data at the 3 DZ-code level; and (3) data on the number of 3 DZ-time-drug combinations and number of unique 3 DZs. The first two datasets are generated using the aforementioned SAS® software from SAS Institute, Cary N.C., and the third dataset is created using, for example, Notepad text editor software. A description of each dataset is provided below. The first dataset contains 11 columns with the following data structure:

| c | d1 | d2 | d4 | d5 | d6 | d7 | case | time | offset | t |
|---|---|---|---|---|---|---|---|---|---|---|
| [] | [] | [] | [] | [] | [] | [] | [] | [] | [] | [] |
| 1 | 1 | 0 | 0 | 0 | 0 | 0 | 0 | −0.02 | 1432.48 | 4 |
| 1 | 1 | 0 | 0 | 0 | 0 | 0 | 0 | −0.01 | 1490.56 | 5 |
| 1 | 1 | 0 | 0 | 0 | 0 | 0 | 1 | 0.00 | 1380.16 | 6 |
| 1 | 1 | 0 | 0 | 0 | 0 | 0 | 0 | 0.01 | 1450.75 | 7 |

where c[ ] represents 3 DZ, d1[ ]-d7[ ] are dummy variables for drug type (see FIG. 1), case[ ] is the number of reports, time[ ] is transformed time variable, which is equal to (t-6)/100 to ensure the calculation of the exponential function, offset[ ] is URDD, and t[ ] is the time variable.

The second dataset contains six columns as defined below:

| mu1[] | x[] | y[] | white[] | age[] | income[] |
|---|---|---|---|---|---|
| 0 | 0.286259 | 0.117560 | 0.90813 | 0.11853 | 0.44222 |
| 0 | 0.287031 | 0.114968 | 0.59772 | 0.10802 | 0.32538 |
| 0 | 0.277471 | 0.116949 | 0.94997 | 0.08474 | 0.39003 |
| 0 | 0.284907 | 0.123349 | 0.95683 | 0.07759 | 0.39512 |

where mu1[ ] is zero for all 3 DZs², x[ ] and y[ ] are the 3 DZ Cartesian coordinates, white[ ] is the percent of Caucasian people in the 3 DZ, age[ ] is the percentage of individuals between ²Recall that the 3 DZ random effect has zero expectation. the ages of 18 to 24 in the 3 DZ, and income[ ] is the median household income/$10,000 for the 3 DZ.³ The last dataset simply contains information on the total number of 3 DZ-by time-by drug combinations and the total number of 3 DZs. The structure of the dataset is as follows: list (n=15,769, m=339) where n=15,769 is the total number of 3 DZ by time by drug combinations and m=339 is the total number of 3 DZs.³Note that the second dataset does not include a variable for 3 DZ. The connection between this dataset and the first dataset depends on the variable c[ ] and the position of the 3 DZ record in the second dataset. Specifically, the rows with c[ ]=k are linked with the k^{th} record in the second dataset. Therefore, it is important to keep the correct position of the 3 DZ record (k^{th} row) in the second dataset so that it corresponds to c[ ]=k in the first dataset.

### Starting Values

Fitting the model in WinBUGS requires, in addition to datasets that describe model specification instructions and observed data, datasets that define the starting values. Two datasets are needed:

(1) a dataset that specifies the structure of the time specific random effect (conditional autoregressive structure); and
(2) a dataset that gives the initial values of the parameters.
The first dataset is structured as follows:

list(num = c(1,2,2,2,2,2,2,1),

| | |
|---|---|
| adj = c( | 2, |

1,3
2,4
3,5
4,6
5,7
6,8
7
),

weights = c( 1,1,1,1,1,1,1,1,1,1,1,1,1)

)

and the second dataset is structured as

list (beta0=0, beta1=0, beta2=0, beta4=0, beta5=0, beta6=0, beta7=0, beta8=0, beta9=0, beta10=0, beta12=0, beta13=0, tau=1, tau1=1).

### Model Fitting

Once all datasets have been created, the basic steps in fitting the model using WinBUGS are as follows: load model, check model, load data, compile, load initial values, generate initial values, phase 1 update (burning), set notes, phase 2 update (sampling from posterior distribution), and save results. Details of each step are described in the WinBUGS manual (Version 1.4; Thomas et al., 2003), which can be downloaded (as of October 2006) from the British website:

http://www.mrc-bsu.cam.ac.uk/bugs/winbugs/manual14.pdf.

### Results of Performing the Method of the Present Invention Poison Control Center Dataset

Overall, 339 valid 3 DZs were available for analysis. This translates into 15,769 drug-by-time-by 3 DZ analysis cells.

### Model Fitting

The correlation between two 3 DZs is defined using the function f(d_{k1,k2};φ) described above. Since φ is a parameter, it can be estimated using the observed data. When the model was fit to the data in WinBUGS, the estimate of φ was very close to zero, which suggests a lack of correlation between two nearby 3 DZs. As pointed out in the WinBUGS manual, there is often little information in the data to support a reasonable estimate of φ. As such, it is recommended that φ be fixed a priori based on substantive knowledge. We set φ to equal 100 miles (or 0.02532), which means that there is zero correlation between two 3 DZs if the distance between their centers is beyond 100 miles. Results of fitting the model described above, with φ fixed at 100 miles are provided in FIG. 2. Of course, the present invention is not limited to this particular distance.

The parameter estimates for β₁ through β₈ represent the effect of drug, independent of time and 3 DZ, on report rates, using hydrocodone as the reference. When these estimates are exponentiated, they have a relative report rate interpretation. For example, the rate of reported morphine abuse is nearly four times higher than the rate of hydrocodone abuse [RR morphine=exp(1.337)=3.808]. Methadone has the highest report rate among the seven drugs. Proportion of Caucasian individuals, proportion of individuals aged 18 to 24 years, and median household income are significantly associated with report rates of opioid analgesic abuse. For the variable proportion of Caucasian individuals, a 5% increase corresponds to a 5% increase [RR per 0.05=exp(0.886×0.05)=1.045] in the rate of opioid abuse. Conversely, a 5% increase in the proportion between the ages of 18 and 24 years corresponds to a 38% decrease [RR per 0.05=exp(−9.516×0.05)=0.621] in the rate of opioid abuse. A $1,000 increase in median household income is associated with a 23% decrease (RR per $1,000=exp(−2.556×0.1)=0.774) in the rate of reported opioid abuse. The variable time has no fixed-effect association with reports of opioid abuse. Since time is incorporated as a random effect, this lack of association implies time is random, without any evidence of structure (δ²−estimate=0.018; 95% CI=0.004 to 0.059).

### Comparison of Drugs

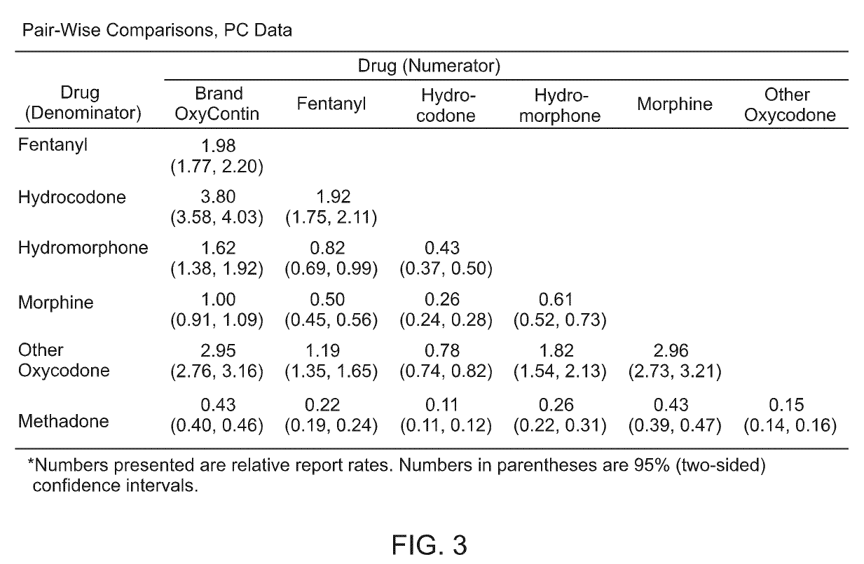

Based on the estimates of parameters β₁ to β₆, we constructed pair-wise comparisons of reported abuse among all seven opioid analgesics. The results are presented in FIG. 3.

Presented in FIG. 3 are the reporting rate ratios (RRs), with 95% confidence intervals in parentheses. Report RRs in FIG. 3 represent comparison of column versus row. For example, the RR of 1.98 in the upper, left-hand cell represents the comparison of OxyContin® versus fentanyl. In this example, the reporting rate of OxyContin® is nearly twice that of fentanyl. The two-sided 95% confidence interval for the report RR excludes 1.0. This means the report rate for OxyContin is significantly higher than fentanyl at the 0.05 significance level. The interpretation of report RRs and 95% confidence intervals are independent of time period and independent of all 3 DZs. As noted above, the results indicate that methadone has the highest report rate and hydrocodone has the lowest report rate among the seven opioids.

### 3 DZ OUTLIERS

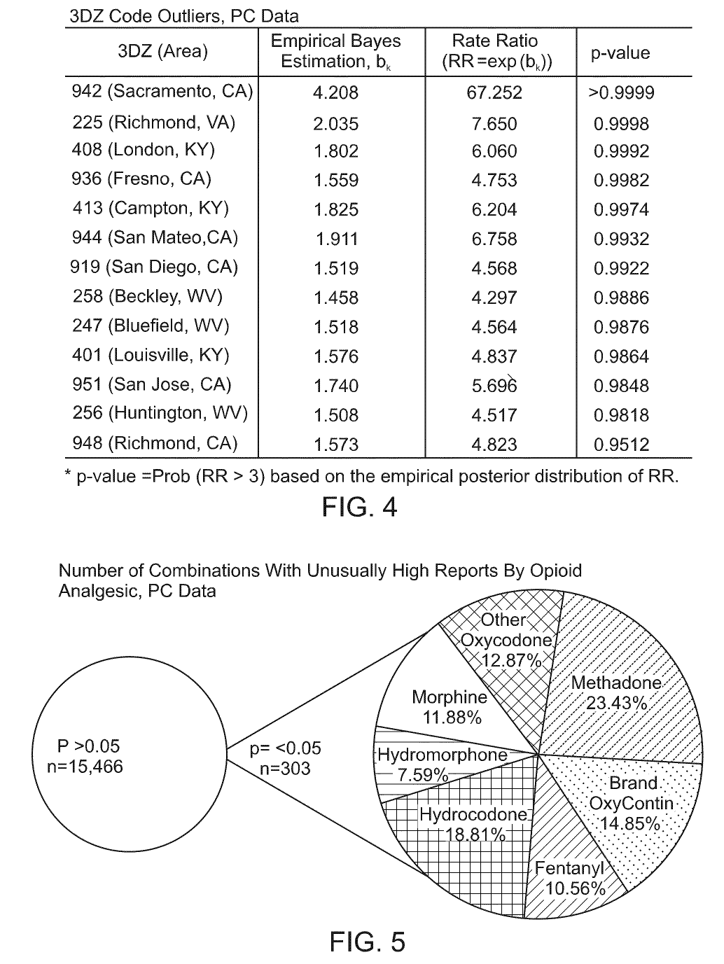

3 DZ outliers are provided in FIG. 4. Reported in FIG. 4 is the empirical Bayes estimate of the random effect bₖ and the relative RR (i.e., RR=exp(bₖ)). RR is interpreted as the rate of opioid abuse for the kₜₕ 3 DZ relative to the population-average rate. Outliers were identified, based on the empirical posterior distribution of RR generated using WinBUGS based on 5,000 MCMC (Markov Chain Monte Carlo) simulations. Specifically, 3 DZ outliers were identified where the probability of RR greater than 3 is greater than 0.95 (i.e., Prob(RR>3)>0.95). This statement specifies the threshold level for determining that a “signal” is present, according to a preferred embodiment of the invention. Those having ordinary skill in statistics will appreciate that another threshold value or statistical criterion could be used, within the scope of the present invention. Thirteen 3 DZs satisfied the above probability statement.

### Outliers of 3DZ-Drug-Time Combinations

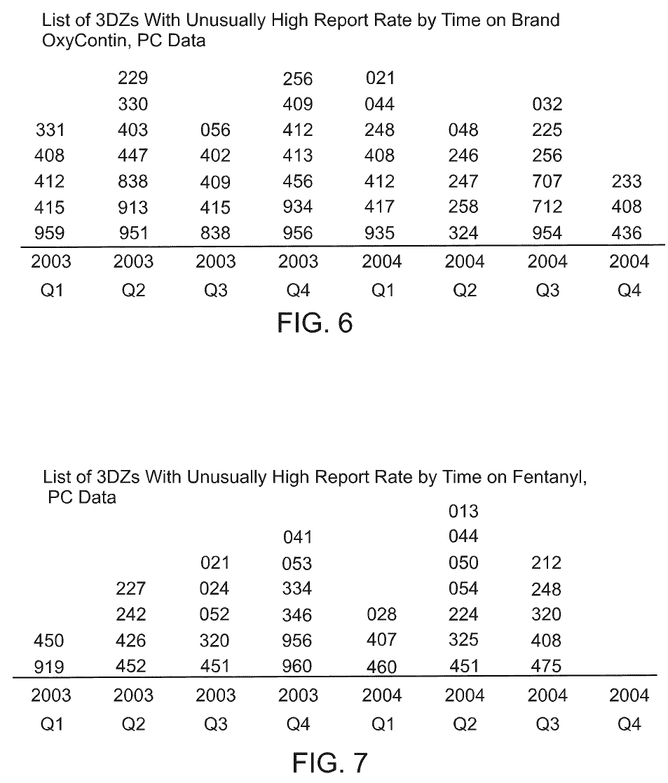

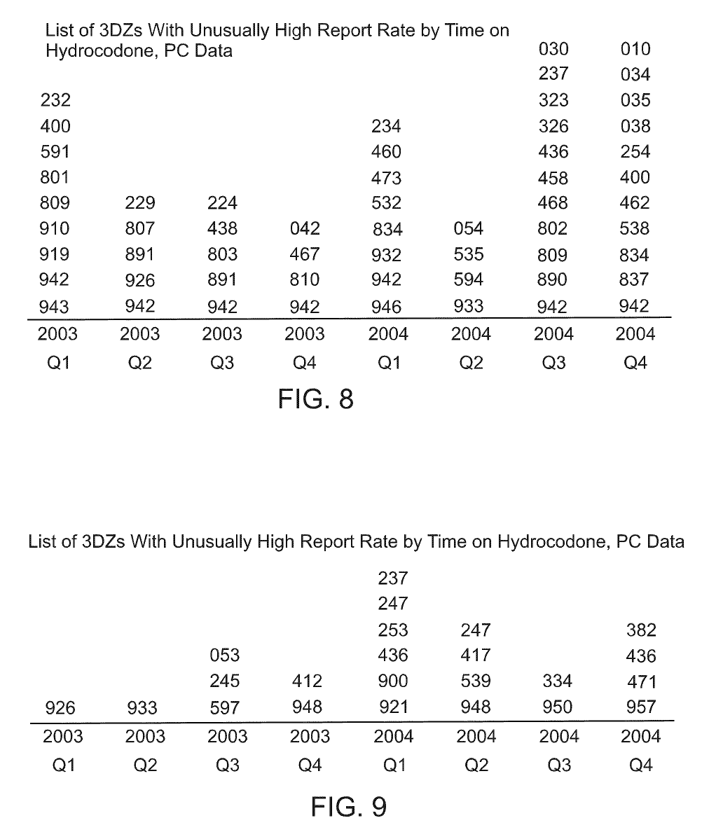

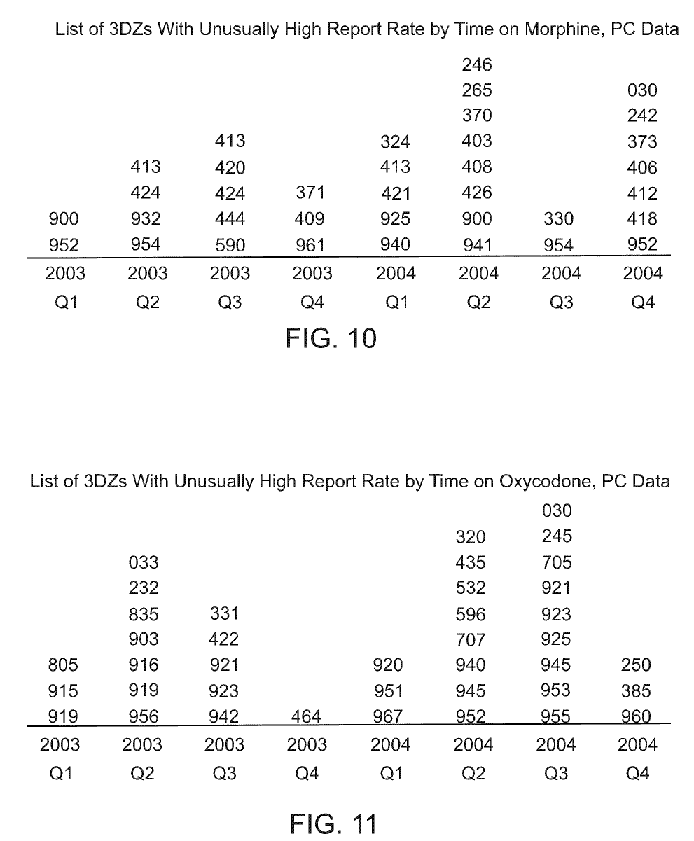

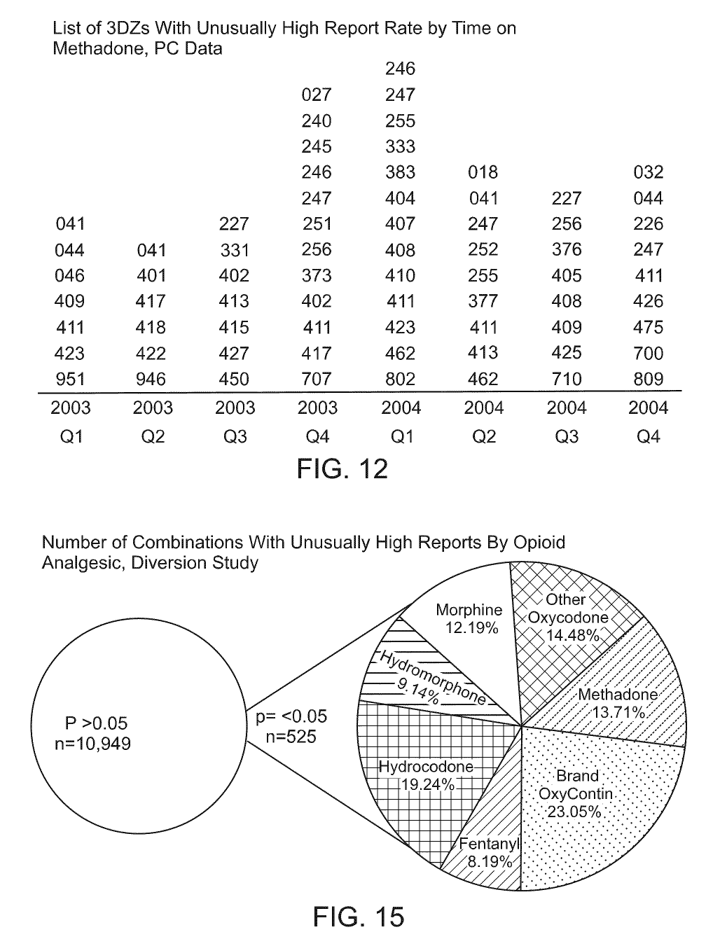

Based on estimates of the fixed effects, the 3 DZ random effect, and the time random effect, we calculated the expected number of reports for any given combination of drug, time period, and 3 DZ (uᵢⱼₖ). We identified an unusually high frequency of reports for any given combination of drug, time period, and 3 DZ that satisfied the following probability statement:

$$Prob ( {Y}_{ijk} \geq {y}_{ijk} \vert {u}_{ijk} ) = {\sum }_{x = {y}_{ijk}}^{∞} \frac{{u}_{ijk}^{x} {e}^{- {u}_{ijk}}}{x !} < 0.05$$

where yᵢⱼₖ is the observed number reports for drug i, time j, and 3 DZ k combination. This inequality represents the probability of obtaining the observed result if the null hypothesis is true, i.e. the model fits the 3 DZ effect as the average of all 3 DZ effects. The results presented in FIG. 5 provide, in part, a summary of the number of drug-by time-by 3 DZ combinations with unusually high reports of opioid abuse. Of the 15,769 valid drug by time by 3 DZ combinations, 303 (1.9%) met the criterion for unusually high. The pie chart on the right in FIG. 5 provides a breakdown of the type of drugs involved. Of the 303 drug-by time-by 3 DZ combinations, methadone is the most prevalent. Lists of unusually high reports by drug by time by 3 DZs are provided in FIGS. 6 through 12.

### Diversion Study DataSet

Overall, 241 valid 3 DZs were available for analysis. This translates to 11,474 drug-by time-by 3 DZ analysis cells.

### Model Fitting

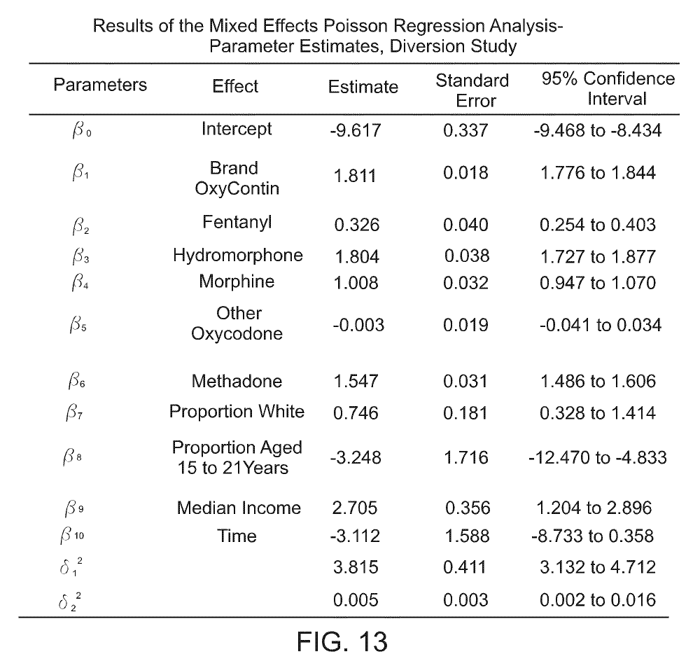

The correlation between two 3 DZs is defined using the function f(d_{k1,k2}; φ) described above. Since φ is a parameter, it can be estimated using the observed data. When the model was fit to the data in WinBUGS, the estimate of φ was very close to zero, which suggests a lack of correlation between two nearby 3 DZs. As pointed out in the WinBUGS manual, there is often little information in the data to support a reasonable estimate of φ. As such, it is recommended that φ be fixed a priori based on substantive knowledge. We set φ to equal 100 miles (or 0.02532), which means that there is zero correlation between two 3 DZs if the distance between their centers is beyond 100 miles (160.9 km). Results of fitting the model described above, with φ fixed at 100 miles, are provided in FIG. 13.

The parameter estimates for β₁ through β₆ represent the effect of drug, independent of time and 3 DZ, on report rates using hydrocodone as the reference. When these estimates are exponentiated, they have a relative report rate interpretation. For example, the rate of reported morphine diversion is nearly three times that of hydrocodone [RR morphine=exp(1.008)=2.740]. OxyContin® has the highest report rate among the seven drugs. Proportion of white (Caucasian) individuals, proportion of individuals aged 18 to 24 years, and median household income are significantly associated with report rates of opioid analgesic diversion. For the variable proportion of white individuals, a 5% increase corresponds to a 0.4% increase [RR per 0.05=exp(0.746×0.05)=1.0037] in the rate of opioid diversion. Conversely, a 5% increase in the proportion between the age of 18 and 24 years corresponds to a 15% decrease (RR per 0.05=exp(−3.248×0.05)=0.850) in the rate of opioid diversion. A per $1,000 increase in median household income is associated with a 31% increase (RR per $1,000=exp(2.705×0.1)=1.311) in the rate of reported opioid diversion. The variable time has no fixed effect association with reports of opioid diversion. Since time is incorporated as a random effect, this lack of association implies time is random without any evidence of linearity

(δ₂²−estimate=0.005; 95% CI=0.002 to 0.016).

### Comparison of Drugs

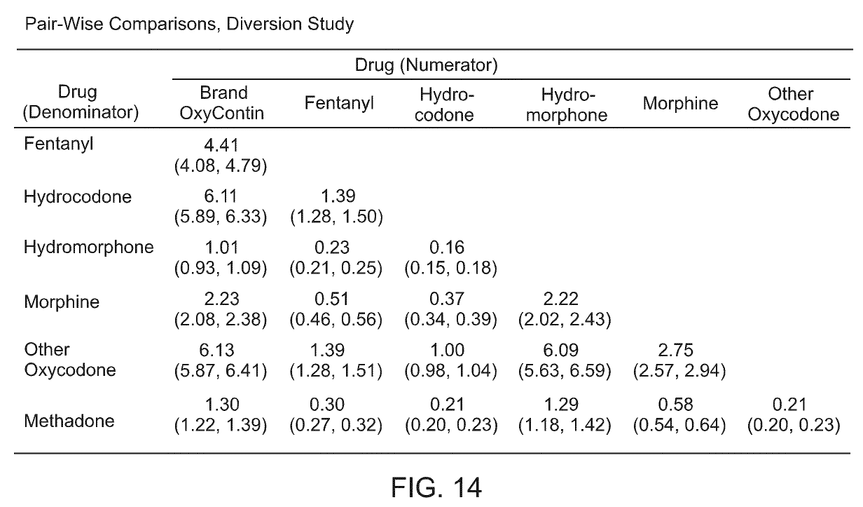

Based on the estimates of parameters β₁ to β₆, we constructed pair-wise comparisons of reported diversion among all seven opioid analgesics. Results are presented in FIG. 14. Numbers presented are relative report rates. Numbers in parentheses are 95% (two-sided) confidence intervals.

Presented in FIG. 14 are the reporting RRs with 95% confidence intervals in parentheses. Report RRs in FIG. 14 represent comparison of column versus row. For example, the RR of 4.41 in the upper, left-hand cell represents the comparison of OxyContin® versus fentanyl. In this example, the reporting rate of OxyContin® is nearly 4.5 times that of fentanyl. The two-sided 95% confidence interval for the report RR excludes 1.0. This means the report rate for OxyContin® is significantly higher than fentanyl at the 0.05 significance level. The interpretation of report RRs and 95% confidence intervals are independent of time period and independent of all 3 DZs. As noted above, the results indicate that OxyContin® has the highest report rate and other oxycodone has the lowest report rate among the seven opioids.

### 3 DZ Outliers

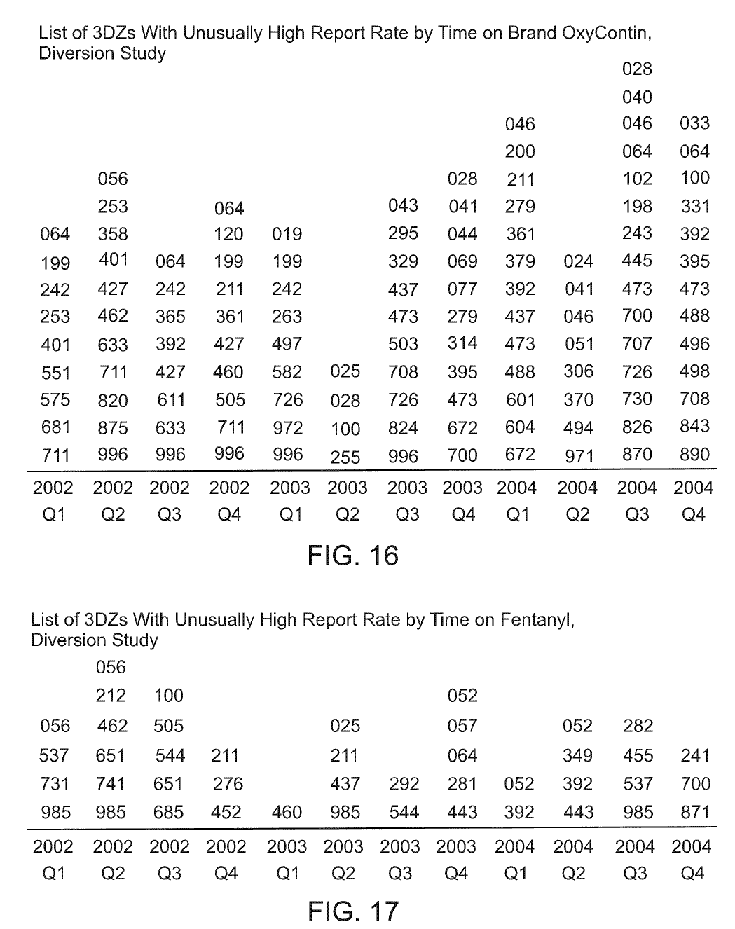

3 DZ outliers are provided in FIG. 16. Reported in FIG. 16 is the empirical Bayes estimate of the random effect bₖ and the relative RR (i.e., RR=exp(bₖ)). RR is interpreted as the rate of opioid diversion for the kₜₕ 3 DZ relative to the population-average rate. Outliers were identified based on the empirical posterior distribution of RR generated using WinBUGS based on 5,000 MCMC simulations. Specifically, 3 DZ outliers were identified where the probability of RR greater than 3 is greater than 0.95 (i.e., Prob(RR>3)>0.95). Twenty-four 3 DZs satisfied the above probability statement.

### Outliers of 3 Dz-Drug-Time Combinations

Based on estimates of the fixed effects, the 3 DZ random effect and the time random effect, we calculated the expected number of reports for any given combination of drug, time period, and 3 DZ (uᵢⱼₖ). We identified unusually high frequency of reports for any given combination of drug, time period, and 3 DZ that satisfied the following probability statement:

$$Prob ( {Y}_{ijk} \geq {y}_{ijk} \vert {u}_{ijk} ) = {\sum }_{x = {y}_{ijk}}^{∞} \frac{{u}_{ijk}^{x} {e}^{- {u}_{ijk}}}{x !} < 0.05$$

where yᵢⱼₖ is the observed number reports for drug i, time j, and 3 DZ k combination. The results presented in FIG. 15 provide, in part, a summary of the number of drug-by time-by 3 DZ combinations with unusually high reports of opioid diversion. Of the 11,474 valid drug-by time-by 3 DZ combinations, 525 (4.6%) met the criterion for unusually high. The pie chart on the right in FIG. 15 provides a breakdown of the type of drugs involved. Of the 525 drug-by time-by 3 DZ combinations, OxyContin® is the most prevalent.

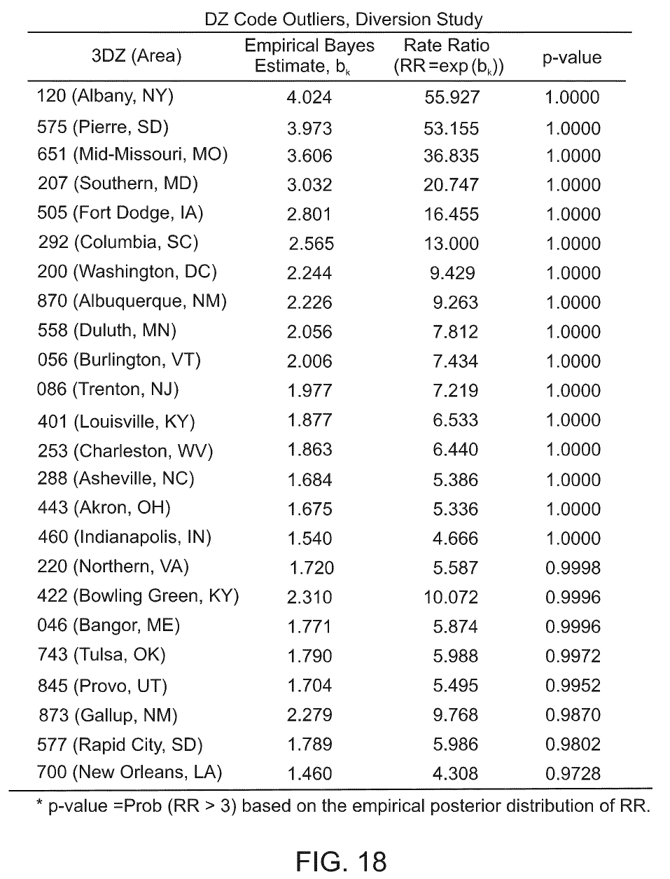

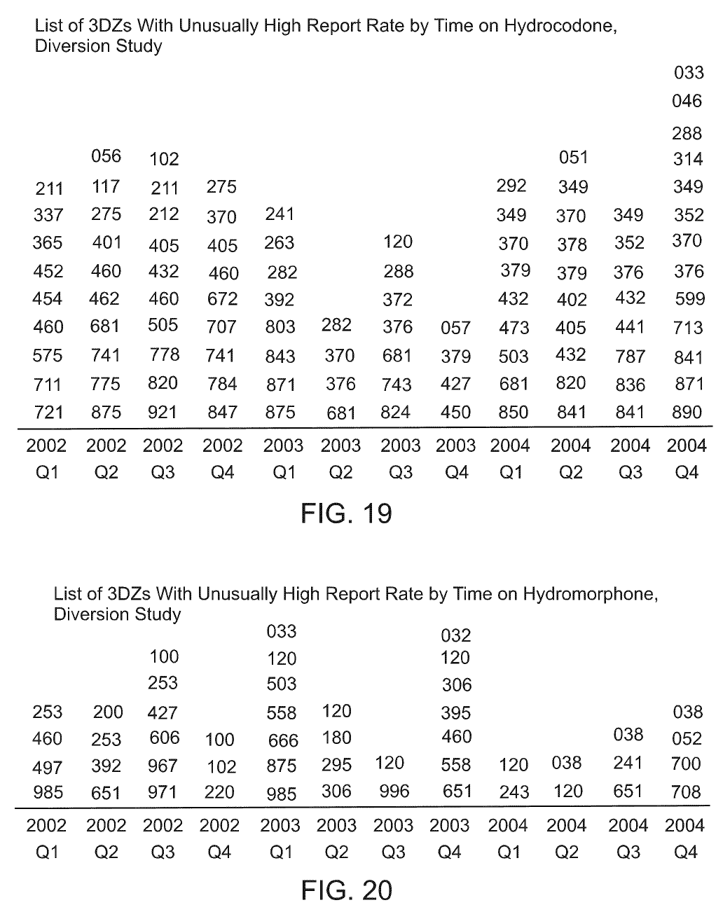

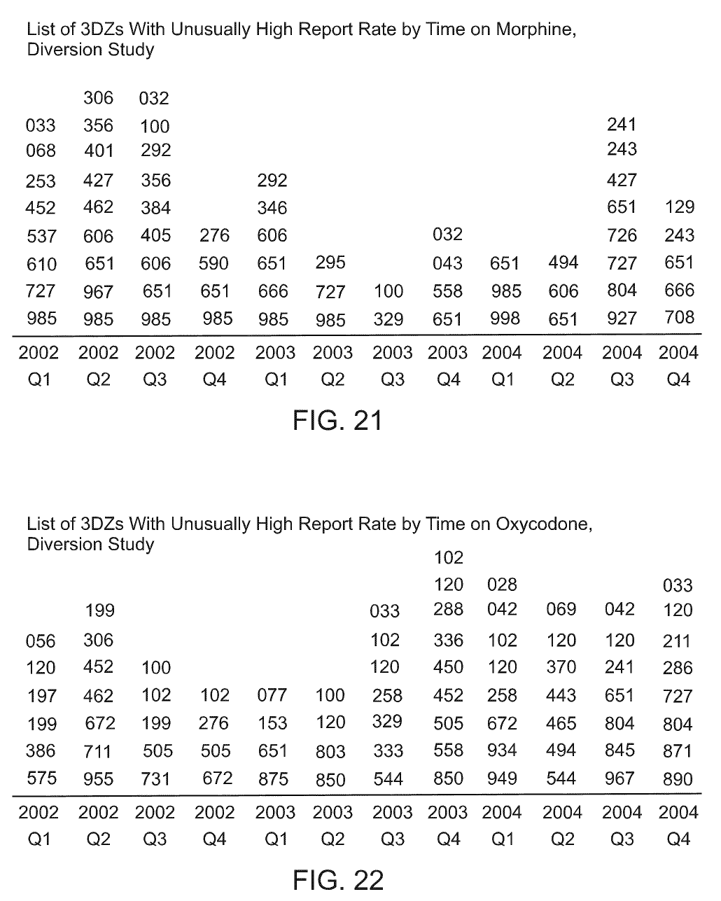

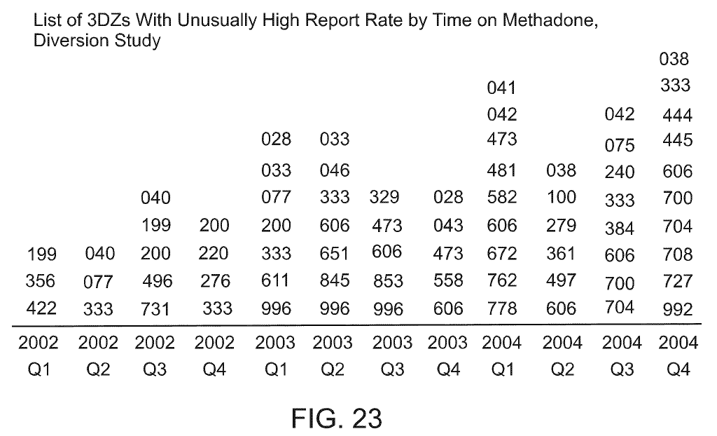

Lists of unusually high reports by drug by time by 3 DZs are provided in FIGS. 16-17 and 19-23. FIG. 18 is a list of 3 DZ Outliers.

### Conclusion

The method of the present invention, by including in its statistical model equation a “denominator” term representing a count of Unique Recipients of Dispensed Drugs (URDD), provides a more accurate, and hence superior, way to identify locations experiencing elevated levels of abuse or diversion of opioid analgesics. This means fewer “false positive” and “false negative” signals, thus permitting public health and law enforcement officials, as well as other public policymakers, to respond more effectively and efficiently to reduce the problem of prescription drug abuse and diversion.

The spatial empirical Bayes approach of the present invention is feasible because WinBUGS and similar Markov Chain Monte Carlo computer programs provide adequate statistical tools for fitting complex spatial regression models to datasets. The method is robust, in that it provides a more reasonable estimate of 3 DZ random effects than did prior art methods. The method is flexible, since adjustment of the mathematical model permits study of possible correlations with a wide range of variables, including time. The method provides an improved method to identify geographic clusters of locations with unusually high reports of drug abuse or diversion.

It will be apparent those having ordinary skill in the statistics and pharmacovigilance fields that the usefulness of the methods disclosed herein is not limited to the specific datasets described, or even to the opioid analgesic industry, but could be adapted for related purposes. For example, it could be applied to other types of adverse drug reactions not involving analgesics. Also, different demographic or economic parameters could be used, depending upon the population being monitored or the problem being detected. Therefore, the invention is not limited to the specific preferred steps or “signal” values described herein, but rather is defined by the following claims. Various changes and modifications are possible within the scope of the inventive concept.

What is claimed is:

1. A method of identifying locations of anomalous levels of pharmaceutical abuse, by analyzing a set of data containing
a specific code for each prescription being monitored;
a time period datum;
a location code;
a count of actual adverse event reports (AER); and
a number of persons dispensed each drug in each location;
comprising the steps of:
fitting a Poisson regression model to said set of data;
calculating associated confidence intervals;
calculating, for each combination of a location code, a drug code, and time period datum, a respective expected number of adverse event reports;
comparing each expected number of adverse event reports with said count of actual adverse event reports; and
flagging, as an outlier, each instance where said count of actual adverse event reports deviates from said expected number of adverse event reports.

2. The method of claim 1, wherein said regression model is a spatial mixed effect regression model.

3. The method of claim 1, further comprising generating a graphical representation of a plurality of geographic locations corresponding to said location codes, and
representing said outliers by at least one distinctive representation.

4. The method of claim 3, wherein said distinctive representation comprises at least one distinctive color.

5. The method of claim 4, wherein a plurality of colors represent respective ranges of numerical values.

6. The method of claim 3, wherein said distinctive representation comprises a simulated 3-dimensional peak, scaled to represent a ratio of said actual AER count to said expected AER count.

7. The method of claim 1, wherein said step of fitting a Poisson regression model to said set of data includes
deriving, for each drug code, a parameter (beta) representing a statistical relationship between said number of persons dispensed said drug and said count of actual adverse event reports.

8. The method of claim 7, wherein said deriving step includes:
preparing a series of model specification instructions, preparing a set of observed data, and preparing a set of starting values; and
processing said instructions and data using a computer program which performs Bayesian analysis using Markov Chain Monte Carlo (MCMC) techniques.

9. The method of claim 7, wherein said parameter deriving step comprises:
performing a regression analysis to determine how a count of Unique Recipients of a Dispensed Drug correlates with said count of actual adverse event reports.

10. The method of claim 1, wherein said regression model fitting step comprises:
loading a model into a computer,
loading starting data values,
compiling a computer program used to process said data values, executing said computer program, and
saving values resulting from said execution of said program.

11. The method of claim 1, wherein said confidence interval calculating step comprises:
deriving a value representing variability of data in said dataset, and dividing said variability value by a square root of how many data values are contained in said dataset.

12. The method of claim 1, wherein said step of calculating an expected number of AERs comprises:
inputting data which specify a conditional autoregressive time structure, inputting initial values of parameters, inputting data characterizing a local population and the number of Unique Recipients of each Dispensed Drug, and executing a computer program which makes Bayesian inferences based upon said inputted data.

13. The method of claim 1, wherein said step of flagging comprises:
providing a flag field in a data record which includes a location code associated with said actual number of adverse event reports,
determining whether or not said actual number of adverse event reports exceeds said expected number and, if said actual value does exceed said expected number,
recording a YES value in said flag field of said data record.

14. The method of claim 1, further comprising
outputting a list of locations where said actual number of AERs deviates from the expected number of AERs according to a predetermined statistical criterion.

15. The method of claim 14, wherein said statistical criterion is a relative report rate exceeding a predetermined threshold value.

16. The method of claim 14, wherein
said statistical criterion is that a probability, that a drug has a Relative Report Rate greater than 3, is greater than 0.95.

17. A method of analyzing a set of data on abuse of pharmaceuticals, to identify locations where data values constitute a “signal” of anomalous abuse, comprising identifying locations for which
Yᵢⱼₖ represents data for drug i at time j in location k,
N is a count of Unique Recipients of the Dispensed Drug (URDD) for drug i at time j in location k,
Yᵢⱼₖ˜Poisson (exp (μ_{φk})*Nᵢⱼₖ)
and the equation
Log (ηᵢⱼₖ)=log(Nᵢⱼₖ)+β₀ +βᵢ(i=1, . . . , 8)D₁ βⱼTime+αᵢIncome+α₂Age+α₃Race+bₖ+T_{y}
yields a statistically significant elevated value,
where Dᵢ (i=1, . . . 8) are indicator variables for drug,
Time is a continuous variable representing year-quarter, Race is the percent of white people in 3 DZ k, Age is the percent of individuals age 18 to 24 years in 3 DZ k, Income is the median household income (US $100,000) for 3 DZ k, bk is the 3 DZ random effect, and
Tj is a year-quarter random effect.

18. A method of identifying locations of anomalous levels of pharmaceutical drug diversion, by analyzing a set of data containing
a specific code for each prescription drug being monitored;
a time period datum;
a location code;
a count of actual drug diversion reports; and
a number of persons dispensed each prescription drug in each location;
comprising the steps of:
fitting a regression model to said set of data;
calculating associated confidence intervals;
calculating, for each combination of
a location code, a drug code, and time period datum,
a respective expected number of drug diversion reports;
comparing each expected number of drug diversion reports with said count of actual drug diversion reports; and
flagging, as a signal, each instance where said count of actual drug diversion reports exceeds said expected number of drug diversion reports.

19. The method of claim 18, wherein said regression model is a spatial mixed effect regression model.
